(19) United States
(12) Patent Application Publication
(10) Pub. No.: US 2026/0307528 A1
(43) Pub. Date: Oct. 8, 2026

(54) AUTOMATED VEHICLE INTEGRATION OF BATTERY STRING

(71) Applicant: PACCAR Inc, Bellevue, WA (US)

(72) Inventors: Stephen Phillips, Anacortes, WA (US); William Duley, Mount Vernon, WA (US)

(21) Appl. No.: 19/170,543

(22) Filed: Apr. 4, 2025

(51) Int. Cl. B60L 53/80; B60L 7/10; B60L 58/12; B60L 58/16; G07C 5/08; H01M 10/42; H01M 10/46; H01M 10/48

(52) U.S. Cl. CPC B60L 53/80; B60L 7/10; B60L 58/12; B60L 58/16; G07C 5/0808; H01M 10/425; H01M 10/46; H01M 10/482; B60L 2240/545; B60L 2240/547; B60L 2240/549; H01M 2010/4271; H01M 2010/4278; H01M 2220/20

(57) ABSTRACT

Methods and systems for integrating a battery string into a vehicle battery system during vehicle operation are disclosed. A method includes detecting, via a controller of the vehicle, presence of a new battery string on a vehicle communication bus after physical installation of the new battery string in a vehicle. The method includes monitoring, during operation of the vehicle, a first electrical characteristic of the vehicle battery system and a second electrical characteristic of the new battery string, and determining an integration window based on the first electrical characteristic and the second electrical characteristic. The method further includes actuating contactors during the integration window to connect the new battery string to the high-voltage bus and incorporate the new battery string into the battery system. In some instances, the methods and systems may be utilized, for example, in a high-capacity battery electric vehicle, such as a tractor-trailer or semi-trailer arrangement.

### BACKGROUND

Electric vehicles (EVs) and electric-hybrid vehicles (EHVs) rely on battery systems for power. The battery systems in some EVs and EHVs, such as electric commercial trucks, include multiple batteries linked in battery strings (e.g., one or more battery packs linked in series or parallel). When replacing a battery string, it is important to synchronize the energy level of the new battery string with the existing battery strings before integrating the new battery string into the vehicle.

Although integration of a new battery string into an existing battery string without synchronizing energy levels is possible, this can lead to increased electromagnetic interference (EMI) and issues such as high inrush current which strain battery cells and/or contactors of the battery string, resulting in damage to the battery system and reduced battery health. Therefore, it is standard practice to synchronize the energy levels of new battery strings. For example, if a truck arrives for servicing with its state of charge (SOC) at 80% and the replacement battery string has its SOC at 40%, the replacement battery string would be charged until its SOC is 80% before it could be installed and integrated on the high-voltage bus of an electric vehicle for use.

Currently, the process for synchronizing the energy level of a new battery string (e.g., discharging and/or charging the replacement battery string and/or existing battery strings to matching SOC levels) is manual and time-intensive, generally requiring several hours at a vehicle servicing location. Additionally, the new battery string and existing battery strings must be maintained in similar operating conditions (i.e., voltage and temperature) to ensure similar charge acceptance by all battery cells. These requirements add significant delays and complexity to battery servicing operations.

### SUMMARY

The present disclosure is directed to systems and methods for automated integration of battery strings in electric vehicles, particularly in multi-string battery configurations used in commercial electric vehicles. The system provides continuous monitoring and automated control of battery string integration, enabling safe and efficient connection of replacement battery packs without requiring manual pre-conditioning or extensive service intervention.

In general, a method of integrating a new (e.g., added or replacement) battery string into a vehicle battery system of an electric vehicle, during vehicle operation, is provided. Electrical characteristics, such as voltage or state of charge, of the new battery string and the vehicle battery system are detected by a controller. Based on a comparison of electrical characteristics, the controller determines an integration window during which the new battery string may be integrated into the vehicle battery system.

In a first particular aspect, a method for integrating a battery string into a vehicle battery system during vehicle operation is disclosed. The method includes a controller detecting the presence of a new battery string on the vehicle communication bus after the battery string has been physically installed in the vehicle. At this stage, the new battery string remains electrically disconnected from the high-voltage bus of the battery-electric vehicle. During vehicle operation, the controller continuously monitors a first electrical characteristic of the vehicle battery system and a second electrical characteristic of the new battery string. Based on these monitored characteristics, the controller determines an appropriate integration window. Once this integration window is identified, the controller transmits a request to the new battery string, instructing it to actuate its contactors. This action connects the new battery string to the high-voltage bus, thereby incorporating it into the vehicle battery system.

In a second particular aspect, a vehicle is equipped with a battery system that includes multiple battery strings electrically connected to a high-voltage bus. A communication bus is also present, and is communicatively coupled to each of these battery strings. The vehicle includes a new battery string that is physically installed and connected to the communication bus. A controller within the vehicle is communicatively linked to this new battery string. The controller detects the presence of the new battery string on the communication bus while the new battery string remains electrically disconnected from the high-voltage bus of the vehicle. During vehicle operation, the controller monitors a first electrical characteristic of the existing vehicle battery system and a second electrical characteristic of the new battery string. Based on these monitored characteristics, the controller determines an appropriate integration window. Once this integration window is identified, the controller transmits a request to the new battery string to actuate its contactors. This establishes an electrical connection between the new battery string and the high-voltage bus, thereby integrating the new battery string into the overall vehicle battery system.

In a third particular aspect, a method for integrating a battery string into a vehicle battery system during vehicle operation is disclosed. The method includes installation of a new battery string at a vehicle service location, where a new battery string is physically installed into the vehicle. This installation occurs regardless of any misalignment between a first electrical characteristic of the vehicle battery system and a second electrical characteristic of the new battery string. At this stage, the new battery string remains electrically disconnected from the high-voltage bus of the vehicle. After installation, the vehicle is operated based on the battery capacity of the existing vehicle battery system, excluding the new battery string. This operation continues until a controller of the vehicle detects an integration window. The integration window is determined based on a similarity between a first electrical characteristic of the vehicle battery system and a second electrical characteristic of the new battery string. Once this integration window is identified, the controller sends a message instructing the new battery string to electrically connect to the high-voltage bus. Following the successful connection of the new battery string to the high-voltage bus, the vehicle resumes operation in accordance with its updated battery capacity, now incorporating the newly integrated battery string.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 illustrates an example vehicle environment including a battery subsystem with multiple battery strings and associated control systems.

FIG. 2 illustrates a block diagram of control systems and battery strings, including integration of a new battery string with existing battery strings in a vehicle.

FIG. 3 illustrates a block diagram showing battery cell monitoring and management functions performed by a battery management system (BMS), according to example embodiments.

FIG. 4 illustrates a flow diagram showing a process for receiving and installing a new battery string in a vehicle, including operation after installation and integration of the new string when matching conditions are met.

FIG. 5 illustrates a flow diagram showing diagnostic checks performed when integrating a new battery string, according to example aspects of the present disclosure.

FIG. 6 illustrates a flow diagram showing a process for performing safety verification when integrating a new battery string, according to example aspects of the present disclosure.

FIG. 7 illustrates a graph showing voltage levels over time during integration of a battery string.

FIG. 8A-8C are example user interface displays showing battery status information before, during, and after integration of a new battery string, including updates to total capacity and remaining range.

FIG. 9 is a block diagram of an example physical components of a computing device or system with which embodiments may be practiced.

### DETAILED DESCRIPTION

As briefly described above, embodiments of the present invention are directed to a method of integrating a new (e.g., added or replacement) battery string into a vehicle battery system of an electric vehicle, during vehicle operation, is provided. Electrical characteristics, such as voltage or state of charge, of the new battery string and the vehicle battery system are detected by a controller. Based on a comparison of electrical characteristics (e.g., voltage, state of charge, and the like) as well as optional health information about the vehicle battery system and new battery string, the controller determines an integration window during which the new battery string may be integrated into the vehicle battery system.

Generally speaking, integrating a new battery string into a vehicle refers to the process of electrically connecting a newly installed battery string to the existing battery system of an electric vehicle through controlled closing of high voltage relays (contactors). This involves physical installation, communication, and electrical connection processes. That is, the new battery string is first mechanically mounted in the vehicle, while remaining electrically isolated from the existing battery system through open contactors. The battery management system (BMS) of the new string is the communicatively connected to the vehicle's control systems (e.g., via a communication bus) to enable monitoring of the condition of the battery string while it remains electrically isolated from a high voltage distribution system of the vehicle (e.g., a high voltage bus). When appropriate conditions are met, a high voltage relay (contactor) may be actuated to connect the new string to the high voltage distribution system of the vehicle. This allows the new battery string to contribute power to operation of the vehicle.

In general, there are a number of conditions that are monitored to ensure safe and effective integration of a new battery string into a vehicle. These conditions include, for example: determining that voltage levels between new and existing strings are sufficiently similar, to ensure safe connection without damaging inrush currents; verifying alignment of the state of charge between the new and existing battery strings; checking for any current flow conditions that may cause electrical hazards, and ensuring proper temperature alignment between the new and existing strings.

Once integrated, the new battery string becomes part of the vehicle's overall battery system, contributing to the total available power capacity and working in conjunction with other strings to power the vehicle's electric systems.

By enabling automatic integration of a new battery string during operation of the vehicle, a number of advantages are realized. For example service time and costs are significantly reduced by eliminating the need for manual synchronization of battery strings at dealership locations and allowing immediate installation without pre-conditioning requirements. This reduction in service bay occupation time directly translates to improved operational efficiency for service centers.

Still further, the automatic battery string integration methods described herein implements sophisticated protection mechanisms that optimize contactor life through controlled connection timing and minimize potentially damaging inrush current during integration events, e.g., by coordinating battery string integration in an integration window where electrical characteristics of the vehicle and new battery string are well aligned. Additionally, electromagnetic interference is reduced through carefully controlled switching operations, while battery health is preserved through temperature-aware integration strategies.

Still further, operator efficiency is substantially improved, due to reduced downtime without requiring special procedures. Specifically, a maximum available system capability is provided, both during partial string availability (e.g., after maintenance and before integration of a new string), and integration of the new string is coordinated in conjunction with potentially disruptive events within a vehicle battery system, such as regenerative braking events. Additionally, thermal issues are monitored throughout the integration process to ensure consistency between existing and new battery strings. The user experience is also enhanced through a clear interface that provides status information and automatically updates range and capacity information as integration proceeds. The system requires no special operator intervention during the integration process, while clearly indicating system capabilities throughout.

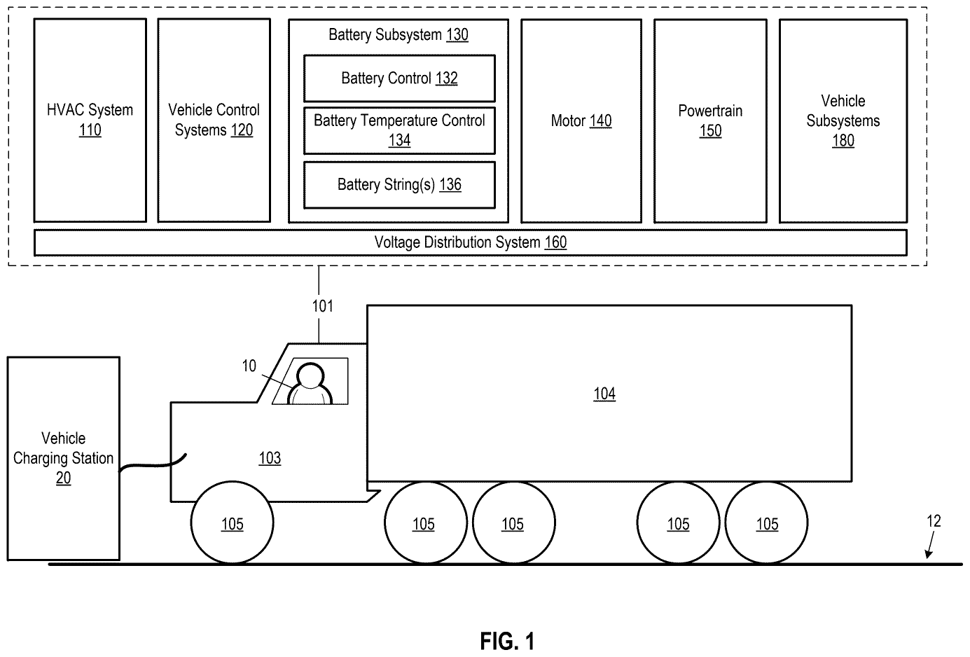

With reference now to FIG. 1, an example vehicle 101 is illustrated within which aspects of the present disclosure can be implemented. For example, FIG. 1 includes a side view of the vehicle 101 further including a schematic view of various components that may be included in the vehicle 101 that may operate as part of example implementations of vehicle cabin heating. In some examples, the vehicle 101 may be a heavy-duty truck such as a part of a tractor-trailer combination. The vehicle 101 may have what is sometimes referred to as, a fifth wheel by which a box-like, flat-bed, or tanker semi-trailer 103 (among other examples) may be attached for transporting cargo or the like. While the vehicle 101 is depicted as a truck in FIG. 1, it should be appreciated that the present technology is applicable to any type of battery-electric vehicle (BEV).

In the example shown, the vehicle 101 has a tractor portion 103 and a trailer portion 104, and is propelled on a plurality of wheels 105 on a driving surface 12. The vehicle 101 may be operated by a vehicle operator 10, who operates the vehicle from a vehicle cabin area. The vehicle cabin area is positioned within the tractor portion 103. In some examples, the vehicle 101 may include a vehicle cabin HVAC system 110, a vehicle controller 120, a battery subsystem 130, a motor 140, a powertrain 150, and various other vehicle subsystems 180.

The vehicle HVAC system 110 may include various components for vehicle cabin heating and cooling, such as a vehicle cabin heater, air conditioning systems (including compressors, condensers and the like), heat pumps, and/or supplemental heating systems. The vehicle HVAC system 110 may include components positioned in the cab (e.g., under a dashboard) or external to the cab, and is operably connected to other systems of the vehicle, such as the vehicle controller 120, as well as a coolant system useable for cooling the battery subsystem 130, motor 140, and powertrain 150.

The vehicle control system 120 may include physical and electrical components used for controlling a vehicle. For example, the vehicle control system 120 may include steering systems, critical control of braking systems, as well as a programmable circuit, such as a computing device, which may be operable to control one or more physical and/or electronic subsystems of the vehicle 101. For example, the vehicle controller 120 may include a vehicle electronic control unit (ECU), and may receive one or more sensor signals associated with the vehicle HVAC system 110, battery subsystem 130, motor 140, powertrain 150, or other vehicle subsystems 180, and may provide control signals, for example via a control bus within the vehicle, for actuating one or more subsystems in response to sensed conditions and/or user inputs. In some example embodiments, the vehicle controller 120 may perform critical operations used for safe operation and control of the vehicle, as described in further detail below.

The battery subsystem 130 includes one or more batteries that are usable to power accessory subsystems within the vehicle 101, as well as batteries used to power the motor 140 and associated powertrain 150. In some example instances, the battery subsystem 130 may include a connector configured to receive a connection from an external electrical source, such as a vehicle charging station 20. In the example shown, the battery subsystem 130 includes a battery control system 132, a battery temperature control system 134, and a plurality of battery strings 136.

The battery control system 132 communicates with the vehicle control system 120 and manages the battery strings 136 included in the battery subsystem 130. The battery control system 132 may correspond to a battery monitoring system (BMS) used within a battery string to manage operating conditions of the battery string, or may correspond to an electronic control unit (ECU) of the vehicle operable to coordinate among various battery strings. The battery temperature control system 134 is generally integrated into and operatively connected to one or more battery strings 136 and the battery control system 132 (at least in the case that the battery control system 132 is integrated int a battery string). In some cases, the battery control system 132 battery temperature control system 134 may be partially or wholly integrated into the individualized battery strings 136, which may report on operating conditions of the battery string. This may include, as noted herein, various faults that may occur in a battery string that might require a halt in operation and servicing of the battery string.

The battery strings 136 are groups of battery cells or batteries configured to provide power for the vehicle 101. In an embodiment, each of battery strings 136 can be configured to provide power at a suitable voltage, for example in a range from at or about 200 volts to at or about 1000 volts. The battery cells included in battery strings 136 can be, as non-limiting examples lithium-ion battery cells, nickel-metal hydride battery cells, or the like.

It is noted that, given the size, weight, and desired hauling capacity of a battery electric vehicle such as disclosed, it is typically the case that a plurality of battery strings 136 are included within the vehicle 101.

The motor 140 and associated powertrain 150 may operate to generate power and to convert the power into movement. For example, the motor 140 may include a power source, such as an engine, and the powertrain 150 various components that operate to convert the engine's power into movement of the vehicle (e.g. the transmission, driveshafts, differential, and axles). In some cases, the powertrain 150 may be one of various types of powertrains (e.g., diesel, hydrogen fuel cell, battery electric). In some examples, the powertrain 150 may be operable with the motor 140 to selectively operate as a generator, for example in the case of a regenerative braking arrangement. The motor 140 can be connected to the high voltage distribution system 160 so as to receive power supplied by the battery strings 136.

In particular embodiments, the battery subsystem 130 includes a high voltage battery pack and the motor includes one or more electric motors. In some instances, a motor 140 and associated powertrain 150 may be packaged within an e-axle (packaging an electric motor, power electronics, and transmission into a single unit). In such instances, one or more electric motors may be used, either in a single e-axle or across a plurality of e-axles. Additionally, one or more high voltage battery packs may be included as well.

In an example where the powertrain 150 comprises a battery electric powertrain operable with an electric motor implementing the motor 140 and battery subsystem 130, the vehicle 101 may be operatively connectable to a vehicle charging station 20. The vehicle charging station 20 may be a home or commercial vehicle charging station capable of supplying external electrical power to the vehicle, in particular for recharging battery subsystem 130.

The vehicle 101 may include one or more other vehicle subsystems 180, such as coolant systems for regulating temperature of operating systems of the vehicle, as well as accessory power systems, lighting systems, communication systems, and various other types of equipment. Each of the other vehicle subsystems 180 may also be powered via the battery subsystem 130.

High voltage distribution system 160 is a power distribution system configured to supply power from battery strings in the battery subsystem 130 to high voltage loads of the vehicle 101, including but not limited to the electrically powered braking system vehicle control systems 120, including the electrically powered braking system 124, the electrically powered power steering system 122, as well as motor 140, and other electrical loads (e.g., HVAC system 110, other vehicle subsystems 180). In examples, the high voltage distribution system 160 may integrate with the battery subsystem 130, and represents a high-voltage bus useable to delivery electrical energy to the various other subsystems of the vehicle. In some instances, the high voltage distribution system 160 may also include a communication bus useable to coordinate among subsystems of the vehicle 101.

Other vehicle subsystems 180 may also be connected to the voltage distribution system 160 so as to receive power therefrom. The other vehicle subsystems 180 can be any suitable electrically powered components included in the vehicle 101, with non-limiting examples including cabin HVACR loads such as HVACR systems or components thereof such as compressors, fans, and the like, cargo compartment HVACR loads, battery heating and/or cooling loads, coolant pumps, fans, DC-to-DC converters, and the like.

As further described below, in typical arrangements, a heavy duty battery electric vehicle will utilize a plurality of battery strings 136 within an overall battery subsystem 130. However, occasionally one or more of the battery strings may require replacement during service operations on the vehicle 101. As discussed below, methods and systems for integration of replacement or new battery strings into a vehicle 101 are provided in which vehicle subsystems may monitor operating conditions of the battery string and the vehicle (including other battery strings of the vehicle) to identify an appropriate time at which the battery string may be integrated (e.g., electrically connected to provide power to the motor 140 and other subsystems of the vehicle). As discussed below, rather than conditioning the vehicle and new battery string as part of the battery string installation process, a battery string may be mechanically installed in a vehicle, and its battery management system may be communicatively connected to other systems of the vehicle, while the high-voltage connections of the battery string may remain disconnected. During vehicle operation, upon a monitoring subsystem of the vehicle (e.g., an ECU or BMS within the vehicle) identifying that conditions are appropriate (e.g., similar voltage, temperature, and adequate state of health and charge), high voltage contactors may be actuated to electrically connect the high voltage connectors of the added battery string to a high voltage bus of the vehicle (e.g. the high voltage distribution system 160), thereby adding the battery capacity of the added battery string to the overall battery capacity of the vehicle.

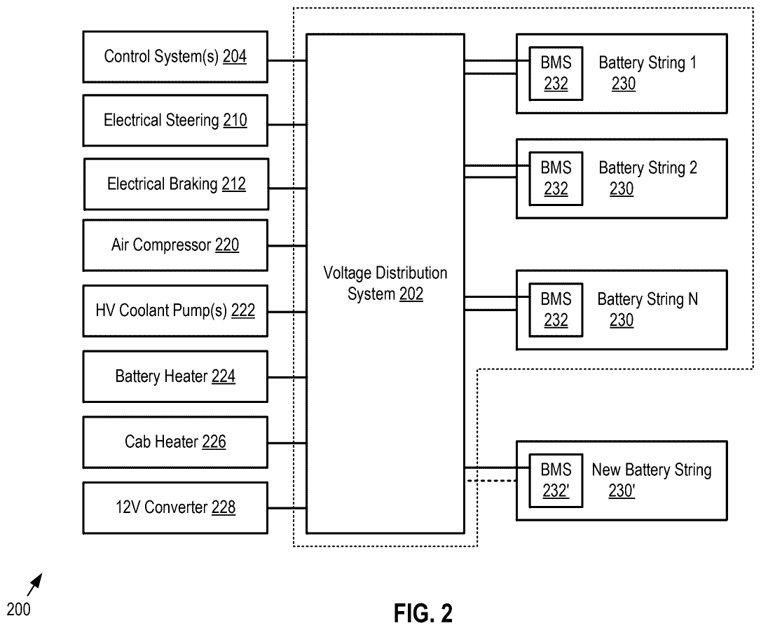

FIG. 2 illustrates a block diagram of control systems and battery strings, including integration of a new battery string with existing battery strings in a vehicle.

FIG. 2 illustrates a block diagram 200 of vehicle subsystems via a voltage distribution system 202. showing electrical and control connections between multiple battery strings and vehicle subsystems, including integration of a new battery string. In general, a voltage distribution system 202 can correspond to voltage distribution system 160 of FIG. 1, and provides electrical connection between a battery subsystem and other vehicle subsystems. In example implementations, the voltage distribution system 202 may be considered either as connecting to or incorporated into a vehicle battery system in conjunction with various battery subsystems.

The block diagram 200 illustrates control systems 204, which control operation of various vehicle subsystems connected to the voltage distribution system 202. Such subsystems include an electrical steering system 210 that provides power steering functionality and an electrical braking system 212 that enables controlled braking operations. Additional vehicle subsystems shown include an air compressor 220 for pneumatic systems, high voltage coolant pumps 222 for thermal management, a battery heater 224 for maintaining optimal battery temperature, a cab heater 226 for passenger comfort, and a 12V converter 228 for powering low-voltage vehicle systems. Other types of subsystems may be included as well, in various embodiments, and may be integrated within the subsystems of the vehicle as illustrated and described above in conjunction with vehicle 101 of FIG. 1.

In the example shown, a plurality of battery strings (denoted as Battery String 1-N) 230, are each equipped with a battery management system (BMS) 232. These strings are connected to the voltage distribution system 202 that distributes power to the various vehicle subsystems.

In the example shown, a new battery string 230′ with its associated BMS 232′ can be attached to the voltage distribution system 202 as well. This may be done, for example, during maintenance or repair operations associated with the vehicle. In doing so, the new battery string 230′ is physically mounted in the vehicle while remaining electrically isolated. That is, the new battery string 230′ may by physically attached to the vehicle and its BMS 232′ may be communicatively connected, e.g., via a communication bus of the voltage distribution system 202, but a high voltage connection is not yet formed from the new battery string 230′ to the voltage distribution system. That is, in the example shown, a set of open contactors either present in the new battery string 230′ or in the voltage distribution system 202 maintain electrical isolation of the new battery string 230′ from a high voltage bus of the voltage distribution system 202, and therefore separate from the other battery strings 230.

In the example shown, a control system, such as one or more control systems 204, and/or a BMS 232 of another of the battery strings, may be configured as a battery system controller (e.g., battery control system 132 of FIG. 1). Such a designated control system is configured to monitor operating parameters of both existing battery strings 230 and the new battery string 230′. These operating parameters can include electrical characteristics of each of these battery strings 230, 230′, including voltage levels, current flow states, and states of charge. Additionally, operating parameters may include temperature conditions of the respective battery strings 230, 230′. The designated control system may then evaluate conditions for integration of the new battery string 230′ into the overall vehicle battery system, including the battery strings 230. That is, an electrical characteristic of the vehicle battery system excluding the new battery string (e.g., representative of all existing battery strings) may be compared to an electrical characteristic of the new battery string 230′. Other operating characteristics may be compared as well. The control system may then evaluate conditions to identify an integration window during which conditions are amenable for integration of the new battery string 230′, e.g., by closing contactors and electrically connecting that new battery string to the high-voltage bus of the voltage distribution system 202.

In example implementations, the control system evaluates operating characteristics, including electrical characteristics, such as: a voltage differential between existing strings and new string; temperature alignment across all strings; an absence of high current events like regenerative braking; and an overall cooling system capacity to provide cooling across all battery strings, including the new battery string 230′. For example, an integration window may exist when one or more of the following electrical and operational conditions occur. In some instances, an integration window may exist if a voltage differential between the existing battery strings 230 and the new battery string 230′ is less than a predetermined threshold voltage difference, such as 7 volts. Other voltage level thresholds may be used as well. An integration window may also exist if a state of charge differential is within +/−5% between the existing battery strings 230 and the new battery string 230′. An integration window may also exist if a temperature of all battery strings is considered to be within normal operating levels. More than one such condition may be required, in some instances, for an integration window to be considered to exist by the control system.

In example implementations, when appropriate conditions are met, the control system may send a message to integrate the new battery string 230′ into the vehicle battery system. This may include, for example, transmitting a message to the battery monitoring system (BMS) 232′ of the new battery string 230′ indicating that it is an appropriate time to actuate contactors that would connect high voltage electrical connections of the new battery string 230′ to a high-voltage bus of the voltage distribution system 202. Alternatively, this may include the control system directly actuating such contactors.

The device operating to actuate the contactors (e.g., BMS 232′) may perform a local safety verification prior to that actuation. The local safety verification may include assessing a state of health of the new battery string 230′ to determine that it has adequate health to safely be integrated into the vehicle battery system. The local safety verification may include assessment of one or more other operating conditions, for example determining whether there are currents or electromagnetic interference signals that would otherwise cause potential hazards during formation of the high voltage electrical connection at the contactors.

Upon determination that conditions are acceptable, the BMS 232′ may actuate the contactors to connect the new battery string 230′ to the voltage distribution system 202, such that the new battery string 230′ may begin to contribute power to the vehicle. A confirmation message may be returned to the control system, which may then update other vehicle subsystems, for example to provide an update regarding the overall state of charge and battery capacity now available via the vehicle battery system, updating or adjusting operating parameters to account for the additional battery capacity (e.g., an updated predicted range or integration status), and the like.

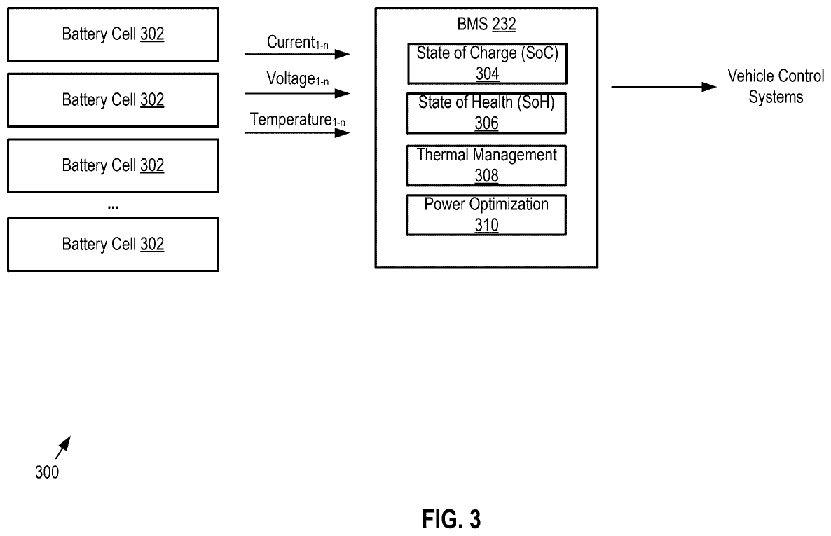

Referring to FIG. 3, a block diagram showing the battery cell monitoring and management functions performed by a battery management system (BMS) 232 is illustrated. As shown, the BMS 232 may correspond to any of the BMS 232 of battery strings 230, or the BMS 232′ of the new battery string 230′.

In the illustration shown, the BMS 232 monitors multiple battery cells 302 within a battery string 230, collecting data on various operating parameters. For example, the BMS may monitor current flow through each battery cell 302 (e.g., Current₁₋ₙ) to determine charge and discharge rates of each cell, abnormal current conditions observed at each cell, current distribution across cells, possible cell failures, and to enable appropriate current sharing between battery strings. The BMS may also monitor individual cell voltages (e.g., Voltage₁₋ₙ) and may calculate voltage differentials between cells, detect voltage imbalances among cells, and otherwise ensure voltage levels remain within safe operating ranges. The voltage levels may be reported by BMS 232 to a control system, for example to determine when voltage conditions are suitable for string integration.

In the example shown, the BMS provides a state of charge (SoC) monitoring function 304, a state of health (SoH) monitoring function 306, a thermal management function 308, and a power optimization function 310. The state of charge monitoring function 306 provides realtime state of charge calculations for each cell, as well as an overall state of charge determination for the overall battery string. The state of charge monitoring function 306 also provides state of charge balancing across cells within the battery string, and may, in some cases, perform a charge acceptance capability assessment. The state of health (SoH) monitoring function 306 is operable at the BMS 232 to track battery aging indicators, cell degradation, performance capability, remaining useful life, and compatibility for integration within the vehicle battery system. The thermal management function 308 monitors temperature of each of the battery cells (Temperature₁₋ₙ), to ensure that individual cell temperatures, thermal gradients, and cooling system operation fall within normal operating parameters for each cell within the string, to prevent overheating conditions. The power optimization function 310 manages power delivery capabilities, current limiting functions, performance balancing, and the like for the battery string.

In examples, the BMS 230 may communicate the voltage, current, state of charge, state of health, and temperature information remotely to enable remote determination of proper conditions for cell integration. In some instances, the BMS 232 may communicate this information to a control system (e.g., another BMS acting as a “master” BMS, or to an ECU or other control system of the vehicle) for coordination of operation of the battery strings, as well as safe, automated integration of battery strings in accordance with the present disclosure.

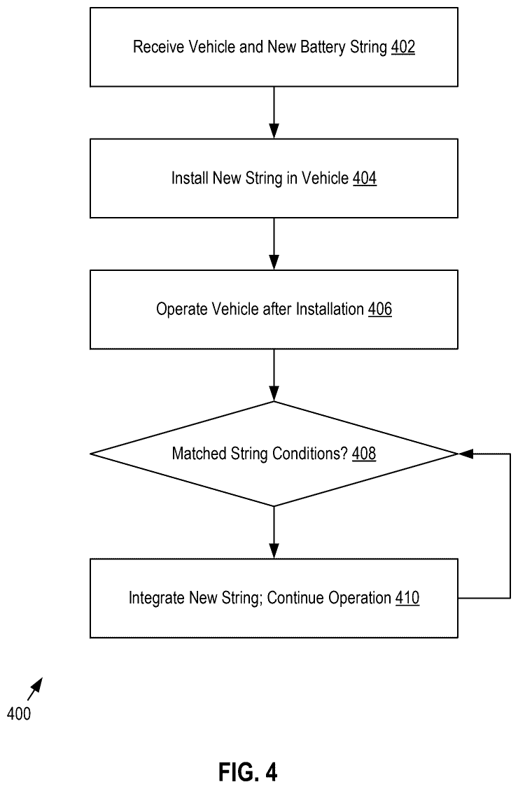

Referring now to FIGS. 4-6, flow diagrams of methods of integrating a new battery string into a vehicle battery system of an electric vehicle, such as the electric vehicle 101 of FIG. 1. FIG. 4 illustrates a flow diagram showing a method 400 for receiving and installing a new battery string in such a vehicle, and may be performed, for example, by an operator and/or servicer of a vehicle, such as a fleet operator. The method 400 includes process steps 402-412.

In the example shown, the method 400 includes receiving the vehicle and new battery string at a service location (step 402). The service may be replacement of a malfunctioning battery string, addition of a new battery string, or the like, to the vehicle. The service may include, e.g., physical inspection of a new string to be installed, verification of compatibility of the new battery string with the vehicle, and other physical/mechanical compatibility assessments, as well as diagnostic checks regarding the general health of a new battery string to be incorporated into the vehicle.

The method 400 further includes physical installation of the new battery string into the vehicle (step 404). This may include, for example, mechanical mounting of the battery string in the vehicle, connection of cooling system interfaces and communication system connections. At this time, the new battery string is maintained in a state where its high voltage supply remains electrically isolated from the vehicle battery system via open contactors of the new battery string. Accordingly, the new battery string may be installed into the vehicle irrespective of misalignment between the electrical characteristics or operational characteristics of the vehicle battery system and the new battery string, due to the new battery string being maintained in a disconnected state relative to the high-voltage bus of the vehicle.

The method 400 further includes, in the example shown, operating the vehicle after installation (step 406). Operating the vehicle after installation may be performed without waiting for the new battery string to be integrated into the vehicle battery system, such that the vehicle electrical power is drawn from existing battery strings. The new battery string remains electrically isolated, but otherwise normal vehicle operation continues. That is, the continued operation of the vehicle occurs in accordance with the battery capacity of the vehicle battery system excluding the new battery string.

The method 400 further includes evaluating, during operation of the vehicle, whether conditions of the vehicle battery system and the new battery string are sufficiently matched to enable integration of the new battery string (step 408). As noted above, this process of evaluation occurs automatically by a control system of the vehicle and includes monitoring relative voltages, states of charge, temperature conditions, current flow states, and safety parameters of the vehicle battery system and the new battery string to determine whether relevant operational parameters are sufficiently similar, and indicative of battery health, to allow for reliable and successful integration of the new battery string.

The method 400 further includes, when conditions are matched, integration of the new battery string and seamless, continued operation of the vehicle (step 410). Integration may include, at the battery string, verifying final safety conditions of the battery string, performing a contactor closure sequence to connect to a high-voltage bus, and confirming successful connection. The continued operation of the vehicle may include, for example, updating system parameters of the vehicle. Updating system parameters may result in updates to a user interface of the vehicle, e.g., to report successful integration of the battery string, updating overall battery capacity and/or range of the vehicle, and the like. Accordingly, the vehicle may be continued to be operated without interruption, while operating parameters of the vehicle are updated to reflect integration of the new battery string.

Referring to the method 400 generally, this process enables service technicians to simplify the installation process by installing a new battery string irrespective of any mismatch between operating parameters, such as voltage or state of charge, of the vehicle and the new battery string. This saves technician time in terms of preconditioning the vehicle or new battery string, and allows an operator to more quickly return to operation of the vehicle, while integration happens during that subsequent operation in a manner that does not require further explicit operator or technician involvement.

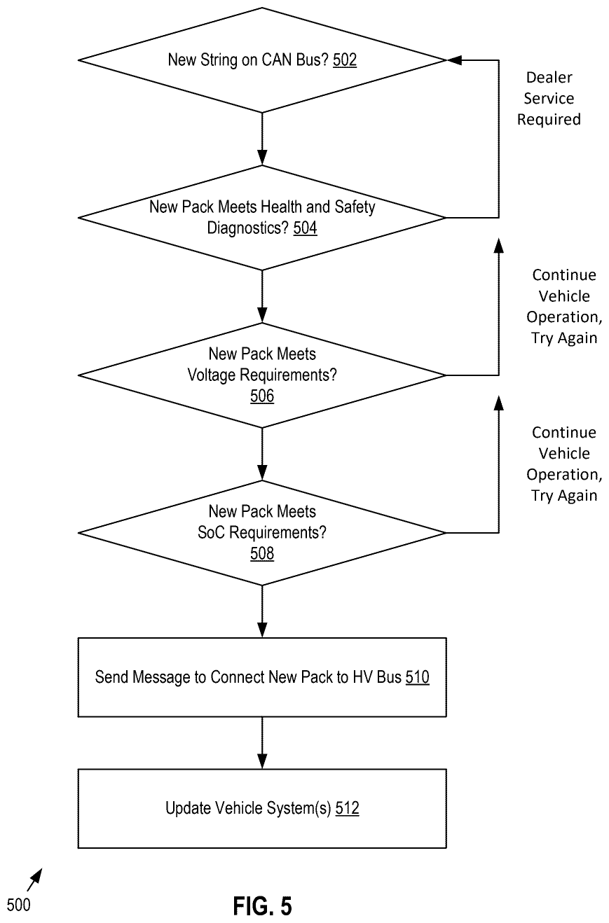

Referring now to FIG. 5, a flow diagram showing a method 500 of integrating a new battery string at a control system of the vehicle is illustrated. The method 500 may be performed by a control system, such as control systems 160, 204 or various BMS systems of other existing battery strings within the vehicle to assist in new battery string integration. The method 500 may be performed during vehicle operation, for example during steps 408-410 of FIG. 4, above.

In the example shown, the method 500 includes control system checking to determine the presence of a new battery string on a vehicle communication bus after installation of the new battery string (step 502). In this context, the new battery string is physically connected to the vehicle and communicatively connected within the vehicle (e.g., via a vehicle CAN bus) but is not electrically connected to a high-voltage bus of the vehicle.

With reference now to FIG. 5, a flow diagram showing a method 500 of integrating a new battery string at a control system of the vehicle is illustrated. The method 500 includes first determining whether a new battery string is present on a vehicle communication bus (step 502). This determination includes verifying establishment of communication with the new battery string, checking protocol compatibility between the new battery string and vehicle systems, verifying signal quality of communications, validating response timing of the new battery string, and confirming error detection capability.

Upon detecting a new string, the method 500 includes determining whether the new battery string meets health and safety diagnostic requirements (step 504). The health and safety diagnostics include performing battery cell resistance measurements to assess internal resistance values, detecting any internal faults within the battery string, verifying proper isolation of the battery string, checking functionality of safety systems, and evaluating diagnostic trouble code status. Still further, a state of battery string health may be calculated to determine how much heat is generated by the battery string under load, or a state of cell to cell balance. These features may indicate how the new battery string might perform while integrated, and further indicate whether the new battery string is electrically safe, or whether any historical faults in that string may rise to critical levels that might suggest integration of the new battery string should not proceed.

In the example shown, the method 500 further includes determining whether electrical characteristics of the vehicle battery system and the new battery string are sufficiently coordinated to enable integration of the new battery string. This can include, for example determining whether voltage requirements are met between the new battery string and existing vehicle battery system (step 506). This determination includes measuring string voltage levels of both the new and existing battery strings, calculating voltage differentials between the strings, assessing voltage stability of the strings, verifying voltage compatibility between strings, and confirming that conditions are safe for electrical connection.

In the example shown, the method 500 additionally includes determining whether state of charge requirements are met between the new battery string and existing vehicle battery system (step 508). This verification includes comparing relative charge states between strings, evaluating charge acceptance capability of the new string, assessing charge balance conditions across strings, verifying charging system compatibility, and confirming that conditions are safe for integration.

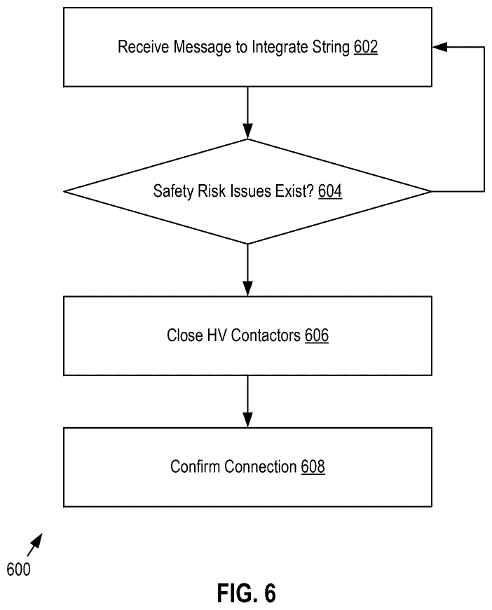

Upon meeting all requirements, the method 500 further includes sending a message to connect the new battery string to the high voltage bus (step 510). The message may be sent from the control system that identifies the integration window to a BMS of the new battery string (e.g., BMS 232′ of new battery string 230′ of FIG. 2). This includes initiating the connection sequence, coordinating contactor closure timing, monitoring the connection process, verifying successful integration, and confirming system stability. This may be based on a connection sequence described below in conjunction with FIG. 6.

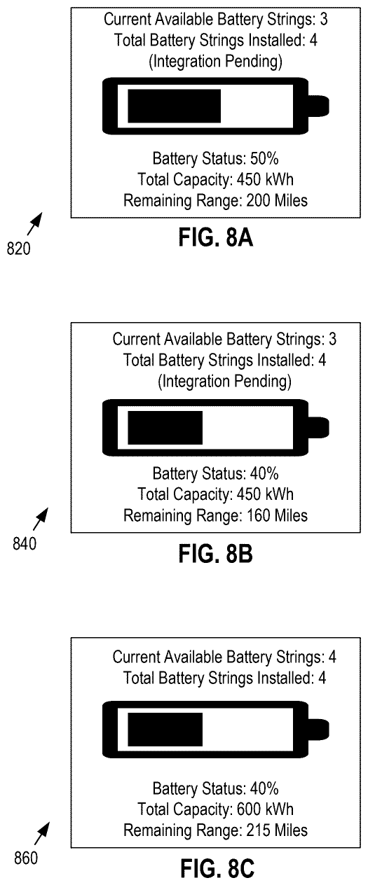

Upon completion of integration, the method 500 includes updating one or more vehicle systems to reflect the modified total energy capacity (step 512). This includes updating the total system capacity, adjusting operating parameters, updating control algorithms, modifying power limitations, and configuring protection settings. Updating of such operating parameters and capacity information may result in updating of one or more user interfaces such as shown in FIGS. 8A-8C, described below.

With reference now to FIG. 6, a flow diagram showing a method 600 of performing a safety verification process when integrating a new battery string is illustrated. The method 600 may be performed, in whole or in part, by a battery monitoring system (BMS) of a new battery string to be integrated into a vehicle battery system, as described herein.

The method 600 includes receiving a message to integrate a battery string (step 602). Upon receiving the integration message, the method may include, e.g., verifying message authenticity, validating command parameters, confirming timing requirements, assessing system readiness, and preparing for the integration sequence.

In the example shown, the method 600 includes determining whether any safety risk issues exist that would prevent safe connection of the new battery string to the high-voltage bus (step 604). This determination includes evaluating current operating conditions, assessing thermal states of the battery strings, verifying electrical parameters, analyzing system capabilities, and confirming safety margins.

If no safety risk issues exist, the method 600 includes closing high voltage contactors to form an electrical connection between the new battery string and the high-voltage bus (step 606). This includes implementing the closure sequence, monitoring contact engagement, controlling closure timing, managing inrush current, and verifying proper operation.

The method 600 further includes confirming successful connection of the new battery string to the high-voltage bus (step 608). This confirmation includes verification of electrical continuity, validation of system response, confirmation of proper integration, assessment of system stability, and update of operational status. The update may be sent back to a control system from which a message is originally received, or to other vehicle subsystems to update operational parameters of the overall vehicle battery subsystem.

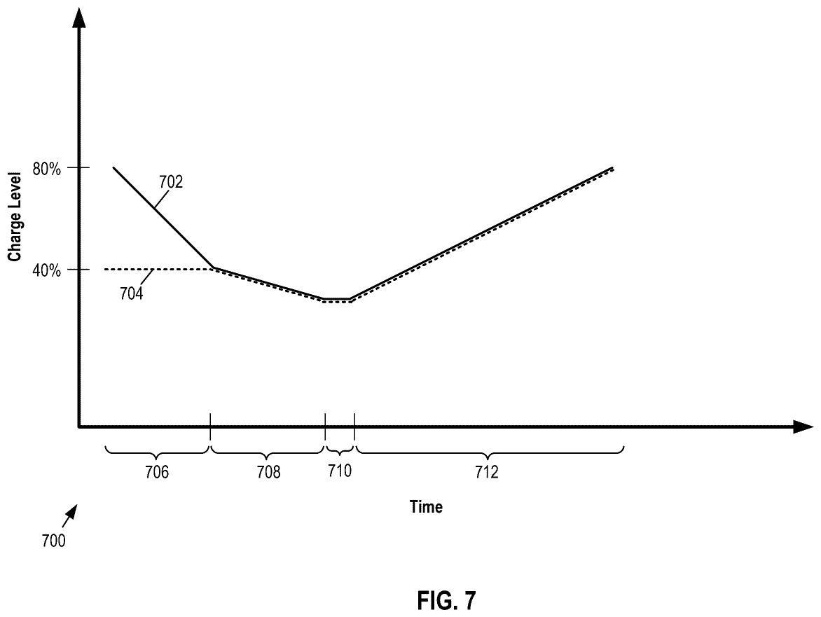

FIG. 7 illustrates a graph 700 showing voltage levels over time during integration of a new battery string into an existing vehicle battery system. The graph depicts charge levels during use/operation of a vehicle after a new battery string is physically installed, e.g., as part of a service operation. The graph 700 includes a first charge level 702, which may represent a charge level of the overall set of battery strings incorporated into the vehicle (e.g., the vehicle battery system), and a second charge level 704, representing a charge level of a new battery string that has been installed in the vehicle, but not yet integrated into the vehicle battery system.

The graph 700 represents a scenario where a vehicle arrives at a service location and is serviced while its existing battery strings are at a higher state of charge (for example, around 80% SOC) compared to a new replacement battery string, which might be installed into the vehicle with a lower state of charge (e.g., approximately 40% state of charge).

In the example shown, a first time period 706 corresponds to a time period during which servicing the vehicle is completed, but the new battery string is not yet integrated and providing electrical energy to the vehicle. As illustrated, the first charge level 702 is depleted during operation of the vehicle, while the second charge level 704 remains generally constant, as no power is drawn from the new battery string during this time period. Additionally, during this time period, a control system, such as a master BMS, is monitoring the state of charge of both the vehicle generally and the new battery string. This may be, for example, based on voltage, state of charge, state of health, or various other information available to and reported by the BMSs of the various battery strings via communication lines within the vehicle.

In the example shown, a second time period 708 is initiated during continued vehicle operation, once the control system determines that the vehicle level state of charge and the new battery string state of charge are sufficiently similar. This represents a window of integration, during which the controller (e.g., the master BMS) may send a message to the BMS of the new battery string indicating that it should close high-voltage contactors, thereby joining the new battery string to the high voltage bus.

The window of integration shown in the graph represents the period during which it is safe to connect the new battery string, taking into account factors such as the voltage differential between existing and new strings being within acceptable limits, the absence of high current events (such as regenerative braking), appropriate temperature conditions across all strings, and a suitable state of charge alignment. This information may be directly gathered by a controller, such as the master BMS or other vehicle control system, or may be reported by the various BMSs 232 of battery strings 136, 230.

It is noted that during the second time period 708, the operator of the vehicle may continue to operate the vehicle as they were during time period 706; the vehicle will operate similarly, e.g., in a manner that does not appear different to the operator. That is, the operator need not take any further specific action to integrate the new battery string to initiate its use in powering the vehicle. However, the incorporation of the new battery string into the overall vehicle battery capacity increases the overall vehicle battery capacity, so the rate of charge depletion may appear to the operator to be slowed relative to the time period 706.

During the third time period 710, the vehicle may pause or cease operation. Accordingly, depletion of the overall state of charge of the vehicle may be further slowed.

During the fourth time period 712, the vehicle may remain ceased in operation, but may be recharged (e.g., at a high voltage electric vehicle charger, such as vehicle charging station 20 of FIG. 1). This may be, for example, at the end of a service day.

During operation, a controller, such as a master battery management system (BMS), monitors the state of charge levels (e.g., including voltage levels, and the like) of both the existing vehicle battery strings and the newly installed but electrically isolated battery string. The master BMS identifies an appropriate “window of integration” when the state of charge levels sufficiently align. This generally corresponds to a time when voltage levels are also generally aligned (e.g., at a time transitioning from time period 606 to time period 608), allowing for safe connection of the new string to the high voltage bus (e.g., via high voltage connectors) without risking damage to the contactors or creating excessive inrush current, either into the new battery string or onto the existing high voltage bus of the vehicle. When the states of charge are appropriately matched (typically, such that voltage on the high voltage bus and within the battery string are within 7 volts), and other conditions such as temperature and current flow requirements are met, the BMS of the new battery string can safely close the contactors to electrically connect and fully integrate into the vehicle's battery subsystem. After the integration occurs, the state of charge (e.g., represented as voltage) levels converge, indicating successful synchronization of the new battery string with the existing vehicle battery system, resulting in increased overall battery capacity for the vehicle.

FIGS. 8A-8C illustrate example user interface displays showing battery status information before, during, and after integration of a new battery string into a vehicle battery system. The user interface displays may be presented to an operator of a vehicle, such as operator 10 of vehicle 101 of FIG. 1.

FIG. 8A shows an example of an initial display state 820 before integration of a new battery string. The display indicates the current available battery strings (3) and total battery strings installed (4), with one string pending integration. The battery status shows 50% charge level, total capacity of 450 kWh, and an example of a remaining range of 200 miles. As such, the operator can see that one battery string is pending integration readily on the operator interface. This may be, for example, during time period 706 of FIG. 7.

FIG. 8B shows a display state 840 during vehicle operation before integration, where the battery status has decreased to 40% charge level. The total capacity remains at 450 kWh based on the three connected strings, with remaining range reduced to 160 miles. The display continues to show one string pending integration. This may correspond, for example, to when a vehicle is approaching an integration window during which conditions may align for integration of a new battery string (e.g., at the beginning of time period 708 of FIG. 7, for example).

FIG. 8C shows a display state 860 after successful integration of the new battery string. The display now indicates four available battery strings, matching the total installed strings, reflecting successful integration. While the battery status remains at 40% charge level, the total capacity has increased to 600 kWh due to the addition of the new string. The remaining range has increased to 215 miles despite the same charge level, reflecting the increased total capacity from the newly integrated string. This may correspond to a time after integration during time periods 708, 710, 712 of FIG. 7.

Accordingly, as can be seen in FIGS. 8A-8C, the user interface display states 820, 840, 860 provide clear feedback to the vehicle operator regarding current system status including number of active versus installed strings, battery charge level and total system capacity, remaining range based on current configuration, and integration status of newly installed strings. Based on updates from controllers within the vehicle, the display will automatically update to reflect changes in system capacity and capabilities as integration occurs during normal vehicle operation, requiring no special operator intervention to complete the integration process.

It is noted that based on operator behavior, it may be that the vehicle is not allowed to have a state of charge that is depleted to a level where there is sufficient match between the vehicle battery system and the new battery string. In such instances, integration of the new battery string may be delayed. Additionally, further alerts may be presented to the operator of the vehicle to indicate a current charge level of the new battery string, or at least an indication that the vehicle requires further reduction of a state of charge to align with and integrate the new battery string, via a user interface similar to the display states described above.

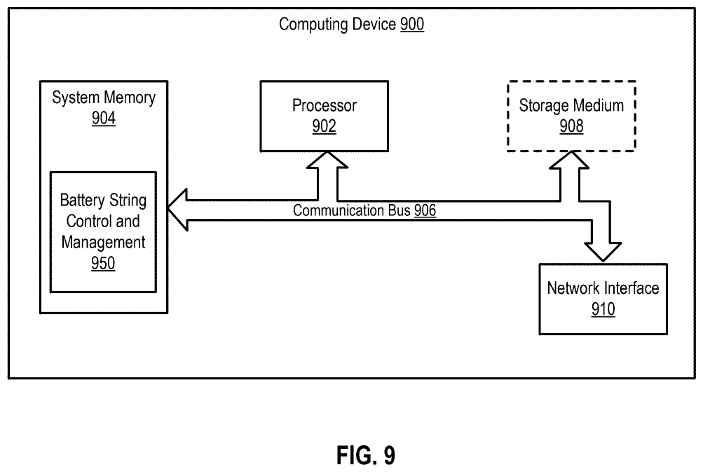

FIG. 9 is a block diagram of an illustrative computing device 900 appropriate for use in accordance with embodiments of the present disclosure. The description below is applicable to the vehicle controller 120, controllers within the battery subsystem 130, such as battery control 130, servers, personal computers, mobile phones, smart phones, tablet computers, embedded computing devices, and other currently available or yet-to-be-developed devices that may be used in accordance with embodiments of the present disclosure.

In its most basic configuration, the computing device 900 includes at least one processor 902 and a system memory 904 connected by a communication bus 906. Depending on the exact configuration and type of device, the system memory 904 may be volatile or nonvolatile memory, such as read-only memory (“ROM”), random access memory (“RAM”), EEPROM, flash memory, or other memory technology. Those of ordinary skill in the art and others will recognize that system memory 904 typically stores data or program modules that are immediately accessible to or currently being operated on by the processor 902. In this regard, the processor 902 may serve as a computational center of the computing device 900 by supporting the execution of instructions. According to one example, the system memory 904 may store instructions for control of the battery subsystem 130, such as operation of vehicle control systems 120, battery control system 132, or controllers within battery strings 136 of FIG. 1, e.g., via battery string integration instructions 950.

As further illustrated in FIG. 9, the computing device 900 may include a network interface 910 comprising one or more components for communicating with other devices over a network. Embodiments of the present disclosure may access basic services that utilize the network interface 910 to perform communications using common network protocols. The network interface 910 may also include a wireless network interface configured to communicate via one or more wireless communication protocols, such as WiFi, 2G, 3G, 4G, 5G, LTE, WiMAX, Bluetooth, or the like.

In the illustrative embodiment depicted in FIG. 9, the computing device 900 also includes a storage medium 908. However, services may be accessed using a computing device that does not include means for persisting data to a local storage medium. Therefore, the storage medium 908 depicted in FIG. 9 is optional. In any event, the storage medium 908 may be volatile or nonvolatile, removable or non-removable, implemented using any technology capable of storing information such as, but not limited to, a hard drive, solid state drive, CD-ROM, DVD, or other magnetic and/or optical disk storage.

As used herein, the term “computer-readable medium” includes volatile and nonvolatile and removable and non-removable media implemented in any method or technology capable of storing information, such as computer-readable instructions, data structures, program modules, or other data. In this regard, the system memory 904 and storage medium 908 depicted in FIG. 9 are examples of computer-readable media.

For ease of illustration and because it is not important for an understanding of the claimed subject matter, FIG. 9 does not show some of the typical components of many computing devices. In this regard, the computing device 900 may include input devices, such as a keyboard, keypad, mouse, trackball, microphone, video camera, touchpad, touchscreen, electronic pen, stylus, or the like. Such input devices may be coupled to the computing device 900 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 900 (e.g., a client device), or can be integral components of the computing device 900. In some embodiments, multiple input devices may be combined into a single, multifunction input device (e.g., a video camera with an integrated microphone). The computing device 900 may also include output devices such as a display, speakers, printer, etc. The output devices may include video output devices such as a display or touchscreen. The output devices also may include audio output devices such as external speakers or earphones. The output devices can be separate from and communicatively coupled to the computing device 900, or can be integral components of the computing device 900. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, Javascript, PythonScript, VBScript, ASPX, Microsoft .NET™ languages such as C #, or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A method of integrating a battery string into a vehicle battery system during vehicle operation, the method comprising:
detecting, via a controller, presence of a new battery string on a vehicle communication bus after physical installation of the new battery string in a vehicle, the new battery string being electrically disconnected from a high-voltage bus of the battery-electric vehicle;
monitoring, during operation of the vehicle, a first electrical characteristic of the vehicle battery system and a second electrical characteristic of the new battery string;
determining, via the controller, an integration window based on the first electrical characteristic and the second electrical characteristic, the integration window corresponding to a time during operation of the vehicle in which a difference between the first electrical characteristic and the second electrical characteristic satisfies an integration threshold; and
transmitting, from the controller to the new battery string, a request to actuate contactors of the new battery string during the integration window to connect the new battery string to the high-voltage bus and incorporate the new battery string into the battery system.

2. The method of claim 1, further comprising:
verifying successful integration of the new battery string; and
updating vehicle systems to reflect a modified total energy capacity of the vehicle battery system.

3. The method of claim 1, further comprising:
monitoring for a current-generating event occurring on the high-voltage bus; and
disallowing actuation of the contactors during the current-generating event.

4. The method of claim 3, wherein the current-generating event includes a detected regenerative braking event.

5. The method of claim 1, wherein the first electrical characteristic and the second characteristic are voltages, and determining the integration window includes determining a voltage differential between the new battery string and battery strings included in the vehicle battery system.

6. The method of claim 1, wherein the first electrical characteristic includes a current flow condition in the vehicle battery system.

7. The method of claim 1, wherein the first electrical characteristic comprises a state of charge of battery strings included in the vehicle battery system and the second characteristic comprises a state of charge of the new battery string.

8. The method of claim 1, further comprising monitoring, during operation of the vehicle, a first temperature of one or more battery strings included in the vehicle battery system and a second temperature of the new battery string.

9. The method of claim 1, wherein the controller comprises at least one of a battery control system of a battery system of the vehicle or a battery monitoring system (BMS) of a battery string integrated into the vehicle battery system.

10. The method of claim 1, further comprising performing, via the controller, one or more battery health diagnostic assessments on the new battery string; the one or more battery health diagnostic assessments including one or more of (1) evaluating diagnostic trouble code status, (2) assessing internal resistance values of battery cells in the new battery string; or (3) determining a cell-to-cell balance status.

11. The method of claim 1, further comprising, at a battery monitoring system (BMS) of the new battery string:
determining whether one or more conditions exist to prevent safe connection of the new battery string to the high-voltage bus; and
in response to determining that no conditions exist to prevent safe connection of the new battery string to the high-voltage bus, actuating contactors to form a connection from the new battery string to the high-voltage bus.

12. A vehicle comprising:
a vehicle battery system including a plurality of battery strings electrically connected to a high-voltage bus;
a communication bus communicatively coupled to each of the plurality of battery strings;
a new battery string physically mounted to the vehicle and communicatively connected to the communication bus;
a controller of the vehicle communicatively connected to the new battery string, the controller being configured to execute instructions to:
detect presence of the new battery string on the communication bus, the new battery string being electrically disconnected from a high-voltage bus of the battery-electric vehicle;
monitor, during operation of the vehicle, a first electrical characteristic of the vehicle battery system and a second electrical characteristic of the new battery string;
determine, via the controller, an integration window based on the first electrical characteristic and the second electrical characteristic, the integration window corresponding to a time during operation of the vehicle in which a difference between the first electrical characteristic and the second electrical characteristic satisfies an integration threshold; and
transmit, from the controller to the new battery string, a request to actuate contactors of the new battery string during the integration window to connect the new battery string to the high-voltage bus and incorporate the new battery string into the battery system.

13. The vehicle of claim 12, wherein each of the plurality of battery strings includes a plurality of battery cells and a battery monitoring system (BMS).

14. The vehicle of claim 12, wherein the new battery string includes a battery monitoring system (BMS), and wherein the BMS of the new battery string receives the request to actuate contactors of the new battery string.

15. The vehicle of claim 14, wherein the BMS of the new battery string is configured to:
determine whether one or more conditions exist to prevent safe connection of the new battery string to the high-voltage bus; and
in response to determining that no conditions exist to prevent safe connection of the new battery string to the high-voltage bus, actuate contactors to form a connection from the new battery string to the high-voltage bus.

16. The vehicle of claim 12, wherein the first electrical characteristic and the second characteristic each include a plurality of electrical characteristics including a voltage of the vehicle battery system and a voltage of the new battery string, as well as a state of charge of the vehicle battery system and a state of charge of the new battery string.

17. The vehicle of claim 12, wherein the controller is further configured to:
verify successful integration of the new battery string; and
update vehicle systems to reflect a modified total energy capacity of the vehicle battery system including an energy capacity of the new battery string.

18. The vehicle of claim 12, wherein the controller is further configured to:
monitor for a regenerative braking event; and
disallowing actuation of the contactors during the regenerative braking event.

19. The vehicle of claim 12, wherein actuation of the contactors to connect the new battery string to the high-voltage bus and incorporate the new battery string into the battery system occurs during operation of the vehicle.

20. A method of integrating a battery string into a vehicle battery system during vehicle operation, the method comprising:
at a vehicle service location, physically installing a new battery string into a vehicle irrespective of misalignment between a first electrical characteristic of the vehicle battery system and a second electrical characteristic of the new battery string, the new battery string remaining electrically disconnected from a high-voltage bus of the battery-electric vehicle;
operating the vehicle, after physically installing the new battery string, in accordance with a battery capacity of the vehicle battery system excluding the new battery string, until an integration window is detected by a controller of the vehicle, wherein:
the integration window is based on similarity of the first electrical characteristic and the second electrical characteristic and corresponds to a time during operation of the vehicle in which the first electrical characteristic and the second electrical characteristic are aligned, and
during the integration window, a controller of the vehicle sends a message to electrically connect the new battery string to the high-voltage bus; and
after the new battery string is connected to the high-voltage bus, continuing operation of the vehicle in accordance with an updated battery capacity of the vehicle battery system including the new battery string.
